(19) United States
(12) Patent Application Publication
(10) Pub. No.: US 2016/0301740 A1
(43) Pub. Date: Oct. 13, 2016

(54) METHOD AND APPARATUS FOR TASK CHALLENGE USING SOCIAL COOPERATION

(71) Applicant: National Tsing Hua University, Hsinchu City (TW)

(72) Inventors: Shan-Hung Wu, Hsinchu (TW); You-Jhih Wong, Keelung City (TW)

(21) Appl. No.: 14/726,614

(22) Filed: Jun. 1, 2015

(30) Foreign Application Priority Data
Apr. 7, 2015 (TW) 104111113

(51) Int. Cl. H04L 29/08; G06F 9/46

(52) U.S. Cl. CPC H04L 67/10; H04L 67/22; G06F 9/465

(57) ABSTRACT

A method and an apparatus for task challenge using social cooperation are provided. The method is adapted for a service apparatus to provide multiple client apparatuses to create and join in a task. In the method, a task created by one client apparatus is received, and the rest of the client apparatuses are invited to join in the task. Next, a guarantee provided by each of the client apparatuses joining in the task is received. Then, a specific operation executed on each of the client apparatuses is detected, and accordingly it is determined whether each of the client apparatuses completes the task. Finally, a manipulation of the guarantees is determined based on whether each of the client apparatuses completes the task.

### CROSS-REFERENCE TO RELATED APPLICATION

This application claims the priority benefit of Taiwan application Ser. No. 104111113, filed on Apr. 7, 2015. The entirety of the above-mentioned patent application is hereby incorporated by reference herein and made a part of this specification.

### BACKGROUND

1. Field of the Invention

The invention is related to a method and an apparatus for task challenge, and more particularly to a method and an apparatus for task challenge using social cooperation.

2. Description of Related Art

When a user sets up a task, it is often the case that the user becomes lazy or relaxes on the standards while performing the task due to lack of urge, which even results in the task not being achieved in the end. For instance, when the user decides to exercise for 180 minutes in a week, the user may easily slack off and fail to achieve the goal in the absence of self-discipline or urge.

To help users complete tasks successfully, many mechanisms have been developed in the past, such as an achievement badge mechanism in which the user wins badges when completing tasks so as to reach achievements, a sharing mechanism that publishes a result of achievement on a social network website through a sharing function of the social network website, a record review mechanism that calculates the tasks completed by the user for the user to review past achievement records anytime, and a guarantee mechanism that requires the user to invest a guarantee prior to performing the task and confiscates the guarantee if the user fails to complete the task.

By means of the mechanisms, although a certain urge is effected on the user, the actual performance is still affected by the way the user handles tasks since these mechanisms are all designed merely for independent users, which thereby has limited effects.

### SUMMARY OF THE INVENTION

A method and a client apparatus for task challenge using social cooperation are provided, which enhances the motivation for a user to complete a task by means of social interaction and investment of a guarantee.

A method and an apparatus for task challenge using social cooperation are adapted for a service apparatus to provide a plurality of client apparatuses to create and join in a task. In the method, a task created by one of the client apparatuses is received, and the rest of the client apparatuses are invited to join in the task. Next, a guarantee provided by each of the client apparatuses joining in the task is received. Then, a specific operation executed on each of the client apparatuses is detected, and accordingly it is determined whether each of the client apparatuses completes the task. Finally, a manipulation of the guarantees is determined based on whether each of the client apparatuses completes the task.

According to an embodiment of the invention, the step of detecting a specific operation executed on each of the client apparatuses and accordingly determining whether each of the client apparatuses completes the task includes determining whether the specific operation satisfies a condition required by the task, so as to verify whether each of the client apparatuses completes the task, wherein the specific operation includes a pressing operation on a physical button, a moving operation on the client apparatus, a touching operation on a touch screen, an unlock operation under a locked status, or a triggering operation with respect to a specific application.

According to an embodiment of the invention, the step of detecting a specific operation executed on each of the client apparatuses and accordingly determining whether each of the client apparatuses completes the task includes executing the specific operation by one of the client apparatuses and providing a execution result to the rest of the client apparatuses, so that the rest of the client apparatuses verify whether the client apparatus providing the execution result completes the task according to the execution result.

According to an embodiment of the invention, the step of determining a manipulation of the guarantees based on whether each of the client apparatuses completes the task includes determining whether all the client apparatuses complete the task, wherein the guarantees provided by all the client apparatuses joining in the task are returned if all the client apparatuses complete the task, and the guarantees are confiscated if at least one of the client apparatuses fails to complete the task.

According to an embodiment of the invention, the step of determining a manipulation of the guarantees based on whether each of the client apparatuses completes the task includes determining whether each of the client apparatuses accepting the invitation completes the task, wherein the guarantee provided by the client apparatus accepting the invitation is confiscated and the guarantee provided by the client apparatus creating the task is returned if the client apparatus accepting the invitation fails to complete the task. If the client apparatus accepting the invitation completes the task, it is further determined whether the client apparatus creating the task also completes the task, and if yes, the guarantees provided by all the client apparatuses joining in the task are returned; if the client apparatus creating the task fails to complete the task, the guarantee provided by the client apparatus creating the task is confiscated while the guarantees provided by the rest of the client apparatuses are returned.

According to an embodiment of the invention, the step of determining a manipulation of the guarantees based on whether each of the client apparatuses completes the task further calculates the time the client apparatus spends on performing the task and determines the manipulation of the guarantee based on whether each of the client apparatuses completes the task within a time limit for the task when the accumulated time exceeds the time limit for the task.

The apparatus for task challenge using social cooperation of the invention includes a communication unit, a storage unit and a processing unit. Herein, the communication unit is configured to create connections to a plurality of external client apparatuses. The storage unit is configured to record a plurality of modules. The processing unit is configured to access and execute the modules recorded in the storage unit. The modules include a task creating module, a guarantee management module and a detection module. Therein, the task creating module is configured to receive a task created by one of the client apparatuses via the communication unit, so as to invite the rest of the client apparatuses to join in the task via the communication unit. The guarantee management module is configured to receive a guarantee provided by each of the client apparatuses joining in the task. The detection module is configured to detect a specific operation executed on each client apparatus and accordingly determines whether each of the client apparatuses completes the task, wherein the guarantee management module includes determining a manipulation of the guarantees based on whether each of the client apparatuses completes the task determined by the detection module.

According to an embodiment of the invention, the detection module includes determining whether the specific operation satisfies a condition required by the task, so as to verify whether each of the client apparatuses completes the task, wherein the specific operation includes a pressing operation on a physical button, a moving operation on the client apparatus, a touching operation on a touch screen, an unlock operation under a locked status, or a triggering operation with respect to a specific application.

According to an embodiment of the invention, the guarantee management module includes determining whether all the client apparatuses complete the task, wherein the guarantees provided by all the client apparatuses joining in the task are returned if all the client apparatuses complete the task, and the guarantees are confiscated if at least one of the client apparatuses fails to complete the task.

According to an embodiment of the invention, the guarantee management module includes determining whether each of the client apparatuses accepting the invitation completes the task, wherein the guarantee provided by the client apparatus accepting the invitation is confiscated while the guarantee provided by the client apparatus creating the task is returned if the client apparatus accepting the invitation fails to complete the task, and it is further determined whether the client apparatus creating the task completes the task if the client apparatuses accepting the invitation completes the task. Therein, if the client apparatus creating the task completes the task, the guarantees provided by all the client apparatuses joining in the task are returned; if the client apparatus creating the task fails to complete the task, the guarantee provided by the client apparatus creating the task is confiscated while the guarantees provided by the rest of the client apparatuses are returned.

Based on the above, the method and apparatus for task challenge using social cooperation demands a plurality of users to join in the task and demands each user to invest a guarantee. Then, it is determined whether to confiscate or return the guarantees based on the result that the user perform the task. Thereby, the invention effectively uses social pressure to urge a specific user or group of users to complete the task.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a block diagram illustrating an apparatus for task challenge using social cooperation according to an embodiment of the invention.

FIG. 2 is a flowchart of a method for task challenge using social cooperation illustrated according to an embodiment of the invention.

FIG. 3 is a schematic diagram of a method for verifying whether a client apparatus completes the task according to an embodiment of the invention.

FIG. 4 is a schematic diagram of a method for verifying whether a client apparatus completes the task according to an embodiment of the invention.

FIG. 5 is a flowchart of a method for task challenge using social cooperation illustrated according to an embodiment of the invention.

FIG. 6 is a flowchart of a method for task challenge using social cooperation illustrated according to an embodiment of the invention.

### DESCRIPTION OF EMBODIMENTS

With respect to a task to be performed by a user, the invention incorporates mechanisms such as social interaction and investment of a guarantee for the user to urge himself or even others to complete the task via cooperation with others or challenging others. By means of the social pressure felt from challenging others, the user is more motivated to complete the task.

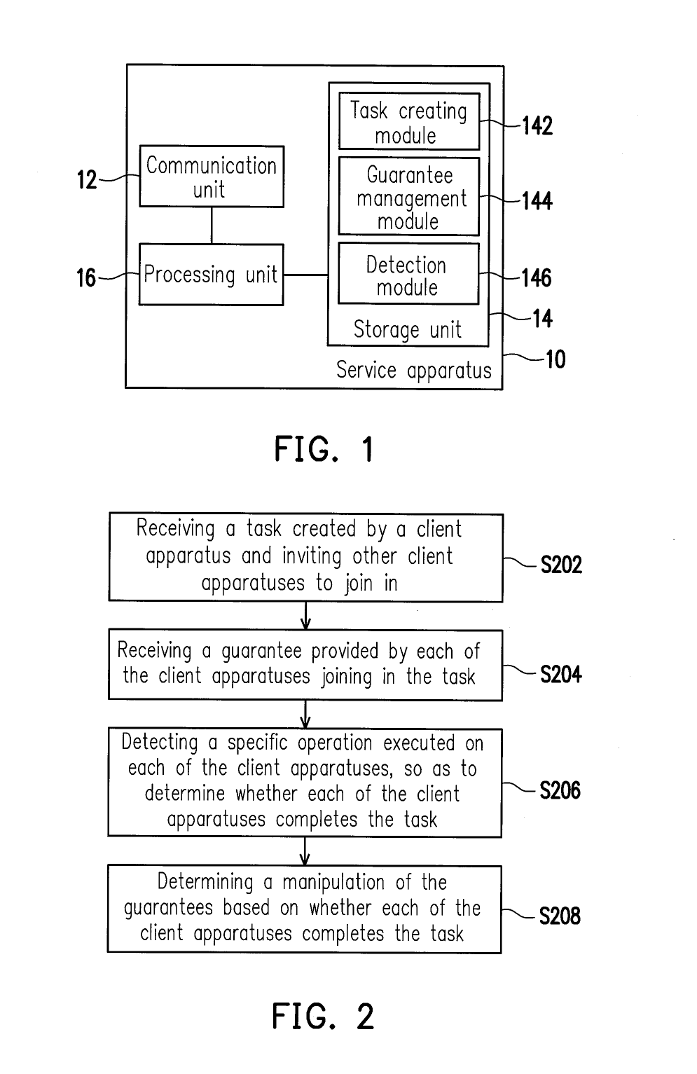

FIG. 1 is a block diagram illustrating an apparatus for task challenge using social cooperation according to an embodiment of the invention. Referring to FIG. 1, the apparatus of the embodiment is, for example, a service apparatus 10 at a service end, including a communication unit 12, a storage unit 14 and a processing unit 16. The service apparatus 10 is, for example, calculation apparatuses such as a file server, a database server, an application server, a workstation or a personal computer, which have computing capabilities, and the variety is not limited thereto.

The communication unit 12 supports at least one of the following wireless signal transmission technologies: Global System for Mobile Communication (GSM) system, Personal Handy-phone System (PHS), Code Division Multiple Access (CDMA), Wireless fidelity (Wi-Fi), Wi-Fi direct, Worldwide Interoperability for Microwave Access (WiMAX), Bluetooth, Radio Repeater or Radio Broadcaster, but the invention is not limited thereto. In the embodiment, the communication unit 12 is for communicating with external client apparatuses.

The storage unit 14 may be fixed or movable random access memory (RAM), read-only memory (ROM), (flash memory) of any form, a similar device or a combination of such devices. In the embodiment, the storage unit 14 is for recording a task creating module 142, a guarantee management module 144 and a detection module 146. The modules are, for example, programs stored in the storage unit 14 that may be loaded by the processing unit 16 in the service apparatus 10, so that the processing unit 16 executes the function of task challenge using social cooperation in the embodiment of the invention.

The processing unit 16 is connected respectively to the communication unit 12 and the storage unit 14, and may be a Central Processing Unit (CPU), or other programmable Microprocessor for normal or special purposes, a Digital Signal Processor (DSP), programmable controller, Application Specific Integrated Circuit (ASIC), other similar devices or a combination of such devices. In the embodiment, the processing unit 16 is for accessing and executing the modules recorded in the storage unit 14, so as to realize the method for task challenge using social cooperation in the embodiment of the invention.

More specifically, FIG. 2 is a flowchart of a method for task challenge using social cooperation illustrated according to an embodiment of the invention. Referring to both FIGS. 1 and 2, the method of the embodiment is adapted for use in the service apparatus 10. Description about detailed steps of the method of the embodiment is provided below with reference to the devices in the service apparatus 10 in FIG. 1.

First, the task creating module 142 receives a task created by a client apparatus, and invites other client apparatuses to join in the task (a step S202). The task may be any verifiable action, such as exercise for 30 minutes, stop using cell phone for 30 minutes, eating vegetable at dinner, and the invention is not limited thereto. In an embodiment, the task creating module 142, for example, initiates the task based on the request from the user and invites other client apparatuses to join in the task based on the user's choices, and then receives confirmation messages sent in response to the invitation from each of the client apparatuses, so as to start the task for the client apparatuses to join in. Herein, the task creating module 142 selects, for example, at least one contact from a plurality of contacts in a contact list, a social network or an instant messenger, or directly selects a pre-set group in the contact list, the social network or the instant messenger, so as to send the invitation, and the invention is not limited thereto.

Next, the guarantee management module 144 receives a guarantee provided by each of the client apparatuses joining in the task (a step S204). The guarantee if, for example, an actual or virtual object recognizable by the service apparatus 10 to serve as a valued item that the user undertakes to complete the task, such as a token, a coupon, accumulated points, labor contribution or time contribution, and the invention is not limited thereto.

After the guarantee management module 144 receives the guarantees provided by all the client apparatus joining in the task, the task is started, and thereby the detection module 146 begins to detect a specific operation executed on each of the client apparatuses, so as to determine whether each of the client apparatuses completes the task (a step S206). Herein, to determine whether the task is completed accurately, the service apparatus 10 in the embodiment of the invention may verify in a plurality of ways. For instance, verification may be done by using a sensor to collect sensing data, or via provision of evidence from the user of any client apparatus for the users of the rest of the client apparatuses to verify. Embodiments are provided below for further descriptions with respect to the ways of verification.

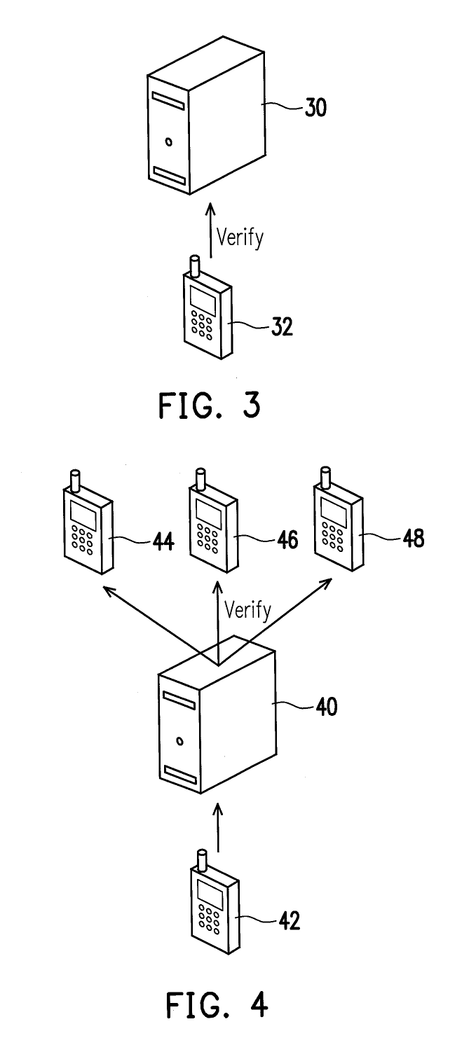

FIGS. 3 and 4 are schematic diagrams of a method for verifying whether a client apparatus completes the task according to an embodiment of the invention. Referring to FIG. 3 first, the embodiment uses a device or sensor disposed on a client apparatus 32 to detect a specific operation executed by the user, such as using a physical button to detect the user's pressing operation, using a tri-axial accelerometer to detect the user's moving operation on the client apparatus 32, using a touch screen to detect the user's touching operation, an unlock operation in a locked state, or a triggering operation with respect to a specific application, and the variety is not limited thereto. On the other hand, referring to FIG. 4, in the embodiment, the user of a client apparatus 42 executes a specific operation and provides a result of execution to other client apparatuses 44, 46 and 48, so that the users of the client apparatuses 44, 46 and 48 verify whether the client apparatus 42 completes the task. For instance, the user of the client apparatus 42 may use a camera of the client apparatus 42 to capture a picture of his dinner and upload the picture to a service apparatus 40, and the service apparatus 40 forwards the picture to other client apparatuses 44, 46 and 48, so as to be verified by the users of the client apparatuses 44, 46 and 48 (such as verifying whether the dinner contains green vegetables). In the end, the client apparatuses 44, 46 and 48 returns the result of verification back to the service apparatus 40, so that the service apparatus 40 determines whether the user of the client apparatus 42 completes the task.

Returning to the flow in FIG. 2, in the end the guarantee management module 144 determines a manipulation of the guarantees based on whether each of the client apparatuses completes the task determined by the detection module 146 (a step S208). Herein, the detection module 146, for example, calculates the time that the client apparatus spends on performing the task, and the guarantee management module 144 determines the manipulation of the guarantees based on whether each of the client apparatuses completes the task within the time limit for the task when the accumulated time exceeds a time limit for the task.

In addition, the guarantee management module 144, for example, decides on different manipulations based on whether the client apparatuses accepting the challenge complete the task and whether the client apparatus initiating the task completes the task.

More specifically, the method for task challenge using social cooperation in the embodiment of the invention includes performing the task via social cooperation and performing the task as a challenge to others, and the invention is not limited thereto. Embodiments are provided below for further descriptions with respect to each example.

Taking social cooperation for example, a plurality of users decide on a task together and hand in guarantees, and the guarantees can be returned to the participants after the task is completed; however, if any participant fails to complete the task, none of the participants can regain the guarantee. If the cooperation fails, the users may set up a higher goal and hand in additional guarantees; after the goal is achieved, the present guarantee and the previous guarantee that was not returned due to the failure can be both returned.

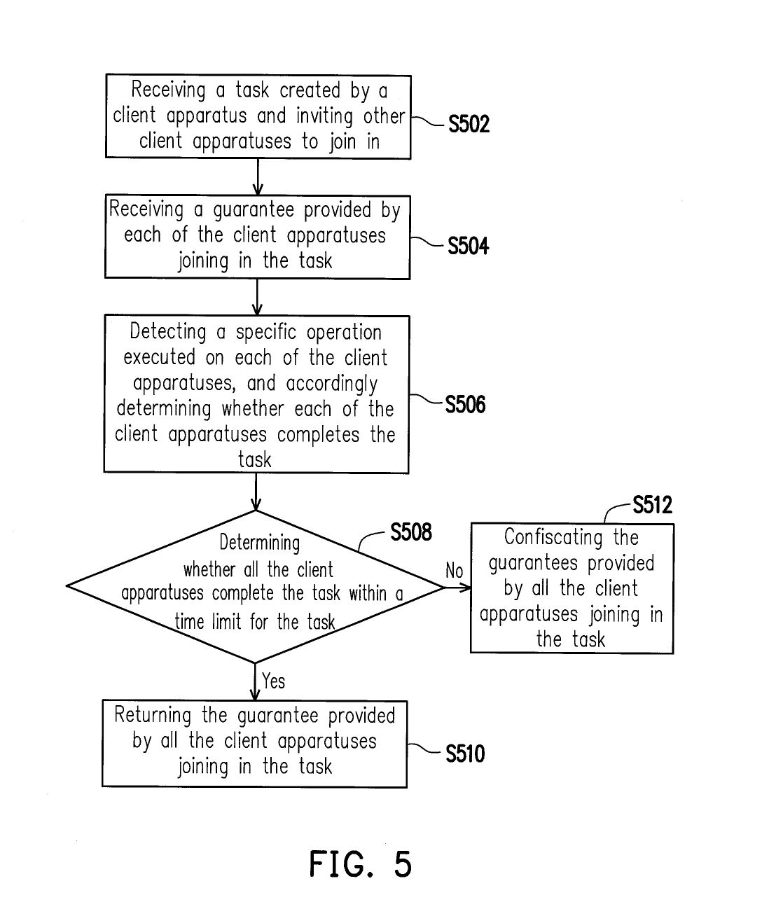

For instance, FIG. 5 is a flowchart of a method for task challenge using social cooperation illustrated according to an embodiment of the invention. Referring to both FIGS. 1 and 5, the method of the embodiment is adapted for use in the service apparatus 10. Description about detailed steps of the method of the embodiment is provided below with reference to the devices in the service apparatus 10 in FIG. 1.

First, the task creating module 142 receives a task created by a client apparatus and invites other client apparatuses to join in the task (a step S502). Next, the guarantee management module 144 receives a guarantee provided by each of the client apparatuses joining in the task (a step S504). Then, the detection module 146 begins to detect a specific operation executed on each of the client apparatuses, and accordingly it is determined whether each of the client apparatuses completes the task (a step S506). The steps S502-S506 described herein are the same as or similar to the steps S202-S206 described in the previous embodiment, and thus detailed implementations are not reiterated below.

Different from the previous embodiments, in this embodiment, the guarantee management module 144 determines whether all the client apparatuses complete the task within a time limit for the task based on whether each of the client apparatuses completes the task and the time for completing the task determined by the detection module 146 (a step S508). Herein, if all client apparatuses complete the task within the time limit for the task, the guarantee management module 144 returns the guarantee provided by all the client apparatuses joining in the task (a step S510), so as to recognize completion of the task by the users of the client apparatuses via mutual cooperation. On the contrary, if any client apparatus fails to complete the task within the time limit for the task, the guarantee management module 144 confiscates the guarantees provided by all the client apparatuses joining in the task (a step S512), so as to urge all the users to strive for completion of the task using the social pressure between all the participants.

By means of the mechanism, the service apparatus 10 in the embodiment of the invention uses the social pressure to enhance the motivation for the users joining in the task to complete the task, so as to stimulate the users to achieve the goal together.

On the other hand, with respect to performing the task as a challenge to others, the user is the initiator that sets up a task and appoints other users to complete the task. The appointed user may choose whether to accept the challenge. If the challenge is accepted, both parties should hand in a guarantee. Herein, if the user accepting the challenge completes the task, it is the task initiator's turn to perform the task. At this time, if the task initiator completes the task, the guarantees of both parties are returned. On the contrary, if the task initiator fails, the guarantee from the user apparatus accepting the challenge is returned while the guarantee from the task initiator is confiscated. In addition, if the user accepting the challenge fails, his guarantee is not returned, and the task initiator can regain his guarantee without performing the task.

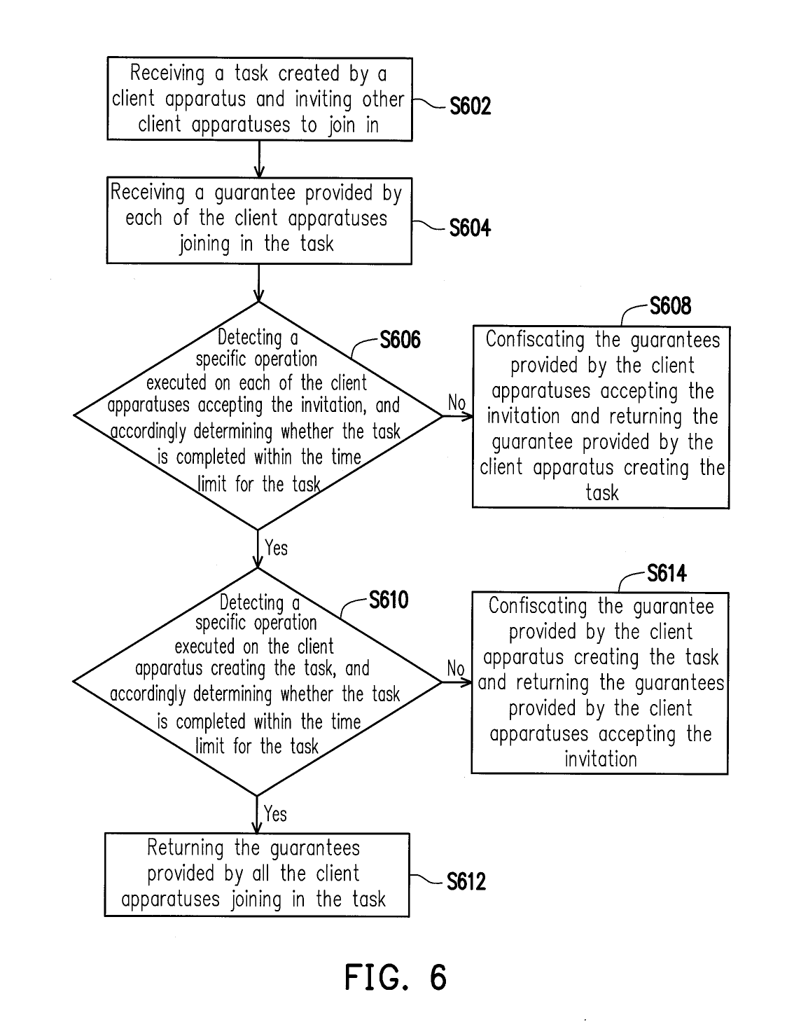

For instance, FIG. 6 is a flowchart of a method for task challenge using social cooperation illustrated according to an embodiment of the invention. Referring to both FIGS. 1 and 6, the method of the embodiment is adapted for use in the service apparatus 10. Description about detailed steps of the method of the embodiment is provided below with reference to the devices in the service apparatus 10 in FIG. 1.

First, the task creating module 142 creates a task created by a client apparatus and invites other client apparatuses to join in the task (a step S602). Next, the guarantee management module 144 receives a guarantee provided by each of the client apparatuses joining in the task (a step S604). The steps S602-S604 described herein are the same as or similar to the steps S202-S204 described in the previous embodiment, and thus detailed implementations are not reiterated below.

Different from the previous embodiment, in this embodiment, after all the client apparatuses joining in the task provide the guarantees, the client apparatuses accepting the invitation perform the task first while the client apparatus creating the task does not need to perform the task. At this time, the detection module 146 detects a specific operation executed on each of the client apparatuses, and accordingly determines whether the client apparatuses complete the task within the time limit for the task (a step S608). Herein, if the client apparatus accepting the invitation fails to complete the task within the time limit for the task, the guarantee management module 144 confiscates the guarantees provided by the client apparatuses accepting the invitation and returns the guarantee provided by the client apparatus creating the task (a step S610), so as to punish the users of the client apparatuses that fail to complete the task.

On the other hand, if the client apparatus accepting the invitation completes the task within the time limit for the task, it is in turn for the client apparatus creating the task to perform the task. At this time, the detection module 146 detects a specific operation executed on the client apparatus creating the task, and accordingly determines whether the client apparatuses completes the task within the time limit for the task (a step S612). Herein, if the client apparatus creating the task completes the task, the guarantee management module 144 returns the guarantees provided by all the client apparatuses joining in the task (a step S614). On the contrary, if the client apparatus creating the task fails to complete the task, the guarantee management module 144 confiscates the guarantee provided by the client apparatus creating the task while returning the guarantees provided by the client apparatuses accepting the invitation (a step S616).

By means of the mechanism, the service apparatus 10 in the embodiment of the invention uses the social pressure to enhance the motivation for the user himself and others to complete the task via challenging others, so as to stimulate the users to achieve the goal.

The method for task challenge using social cooperation may be applied to a variety of situations in daily lives to urge the user to achieve a variety of tasks. Another embodiment is described in detail below for further description.

In an embodiment, assuming that a specific application is installed in a cell phone of a user and functions to help the user exercise periodically and during interstice of time. In this application, the guarantees are set to be game points. By means of this application, the user may find several friends to set up a weekly amount of exercise and invest game points. Within the next week, as long as one user fails to achieve the target amount of exercise, the application confiscates the game points. On the other hand, the user may also initiate a challenge of a set of actions at any time, such as 30 sit-ups, and challenge other users after investment of game points. If the user receiving the challenge chooses to accept the challenge, he has to invest game points as well. If the user accepting the challenge completes the actions, it is the initiator's turn to complete the actions. If the initiator fails to complete the actions, the invested game points are confiscated. The application is able to determine whether the user completes the task via the apparatus itself, such as determining the user's actions via a gravity sensor to confirm whether the user completes the pre-determined actions. By means of the application, the user is able to urge himself to keep the habit of periodic exercise.

In another embodiment, assuming that a specific application is installed in a cell phone of a user and functions to help the user eat more green vegetables, and other settings are as described in the previous embodiment. Different from the previous embodiment, in this embodiment, the user captures a picture of the foods that he eats by using a camera and sends the picture to other users, so that other users determine whether the user eats green vegetables. By means of the application, the user is able to urge himself to eat more green vegetables.

In another embodiment, assuming that a specific application is installed in a cell phone of a user and functions to prevent the user from phubbing within a certain period of time. The guarantees set in this application are tokens in the application, and users may purchase the tokens as the guarantees in the application. The user may create a task of avoiding cell phones within 30 minutes together with the friends that he studies with, and all the participants pay the tokens. If all the participants complete the task, all of the participants are able to regain the tokens; on the contrary, if any participant fails to complete the task, the tokens of all the participants are confiscated. By means of the application, the user is able to urge himself and others to concentrate on studies together.

In view of the above, the method for task challenge using social cooperation provides the task that one or a plurality of users set up to achieve, and the users joining the task are urged to strive together to complete the task via the investment of the guarantees. Thereby, the user not only is more motivated to complete the task, he can also interact with others and encourage each other to complete the task together.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A method for task challenge using social cooperation, adapted for a service apparatus to provide a plurality of client apparatuses to create and join in a task, comprising:
receiving a task created by one of the client apparatuses and inviting the rest of the client apparatuses to join in;
receiving a guarantee provided by each of the client apparatuses joining in the task;
detecting a specific operation executed on each of the client apparatuses, so as to determine whether each of the client apparatuses completes the task; and
determining a manipulation of the guarantees based on whether each of the client apparatuses completes the task.

2. The method for task challenge using social cooperation according to claim 1, wherein detecting the specific operation executed on each of the client apparatuses, so as to determine whether each of the client apparatuses completes the task comprises:
determining whether the specific operation satisfies a condition required by the task, so as to verify whether each of the client apparatuses completes the task, wherein the specific operation comprises a pressing operation on a physical button, a moving operation on the client apparatus, a touching operation on a touch screen, an unlock operation under a locked status, or a triggering operation with respect to a specific application.

3. The method for task challenge using social cooperation according to claim 1, wherein the step of detecting the specific operation executed on each of the client apparatuses, so as to determine whether each of the client apparatuses completes the task comprises:
performing the specific operation by one of the client apparatuses and providing an execution result to the rest of the client apparatuses; and
verifying whether the client apparatus providing the execution result completes the task by the rest of the client apparatuses according to the execution result.

4. The method for task challenge using social cooperation according to claim 1, wherein the step of determining the manipulation of the guarantees based on whether each of the client apparatuses completes the task comprises:
determining whether all the client apparatuses complete the task within a time limit for the task;
returning the guarantees provided by all the client apparatuses joining in the task if all the client apparatuses complete the task; and
confiscating the guarantees if at least one of the client apparatuses fails to complete the task.

5. The method for task challenge using social cooperation according to claim 1, wherein the step of determining the manipulation of the guarantees based on whether each of the client apparatuses completes the task comprises:
determining whether each of the client apparatuses accepting the invitation completes the task within a time limit for the task;
confiscating the guarantee provided by the client apparatus accepting the invitation and returning the guarantee provided by the client apparatus creating the task if the client apparatus accepting the invitation fails to complete the task;
determining whether the client apparatus creating the task completes the task within the time limit for the task if the client apparatus accepting the invitation completes the task;
returning the guarantees provided by all the client apparatuses joining in the task if the client apparatus creating the task completes the task; and
confiscating the guarantee provided by the client apparatus creating the invitation and returning the guarantees provided by the rest of the client apparatuses if the client apparatus creating the task fails to complete the task.

6. The method for task challenge using social cooperation according to claim 1, wherein the step of determining the manipulation of the guarantees based on whether each of the client apparatuses completes the task further comprises:
calculating the time that the client apparatus spends on executing the task; and
determining the manipulation of the guarantee based on whether each of the client apparatuses completes the task within a time limit for the task when the accumulated time exceeds the time limit for the task.

7. An apparatus for task challenge using social cooperation, comprising:
a communication unit, configured to establish connections to a plurality of external client apparatuses;
a storage unit, configured to record a plurality of modules; and
a processing unit, configured to store and execute the modules recorded in the storage unit, the modules comprising:
a task creating module, configured to receive a task created by one of the client apparatuses via the communication unit, so as to invite the rest of the client apparatuses to join in the task via the communication unit;
a guarantee management module, configured to receive a guarantee provided by each of the client apparatuses joining in the task;
a detection module, configured to detect a specific operation executed on each of the client apparatuses, so as to determine whether each of the client apparatuses completes the task, wherein
the guarantee management module determines a manipulation of the guarantees based on whether each of the client apparatuses completes the task detected by the detection module.

8. The apparatus according to claim 7, wherein the detection module comprises determining whether the specific operation satisfies the condition required by the task, so as to verify whether each of the client apparatuses completes the task, wherein the specific operation comprises a pressing operation on a physical button, a moving operation on the client apparatus, a touching operation on a touch screen, an unlock operation under a locked status, or a triggering operation with respect to a specific application.

9. The apparatus according to claim 7, wherein the guarantee management module comprises determining whether all client apparatuses complete the task, wherein
the guarantees provided by all the client apparatuses joining in the task are returned if all the client apparatuses complete the task; and
the guarantees are confiscated if at least one of the client apparatuses fails to complete the task.

10. The apparatus according to claim 7, wherein the guarantee management module comprises determining whether each of the client apparatuses accepting the invitation completes the task, wherein
the guarantee provided by the client apparatus accepting the invitation is confiscated and the guarantee provided by the client apparatus creating the task is returned if the client apparatus accepting the invitation fails to complete the task;
whether the client apparatus creating the task completes the task is determined if all the client apparatuses accepting the invitation complete the task;
the guarantees provided by all the client apparatuses joining in the task are returned if the client apparatus creating the task completes the task; and
the guarantee provided by the client apparatus creating the invitation is confiscated and the guarantees provided by the rest of the client apparatuses are returned if the client apparatus creating the task fails to complete the task.
